(19) United States
(12) Patent Application Publication
(10) Pub. No.: US 2022/0333665 A1
(43) Pub. Date: Oct. 20, 2022

(54) A Damping Assembly

(71) Applicant: XDynamics Limited, Hong Kong (HK)

(72) Inventor: Man Wah Chan, Mid-Levels (HK)

(21) Appl. No.: 17/627,644

(22) PCT Filed: Dec. 19, 2019
(86) PCT No.: PCT/CN2019/126699

§ 371 Date: Jan. 15, 2022

(51) Int. Cl. F16F 15/02; B64C 17/00; B64C 39/02

(52) U.S. Cl. CPC F16F 15/02; B64C 17/00; B64C 39/024

(57) ABSTRACT

The invention relates to a damping assembly for use in an unmanned vehicle. The damping assemblies comprises a positioning structure configured to support one or more components of the unmanned vehicle; a damping system comprising at least one first damping unit and at least one second damping unit arranged at the positioning structure, the at least one first damping unit and the at least one second damping unit being deformable along an axis of deformation of the damping system to thereby reduce transmission of vibration to the supported one or more components; wherein, in response to the force acting upon the positioning structure, the first damping unit is compressed along the axis of deformation, and simultaneously, the second damping unit is extended along the axis of deformation.

### FIELD OF THE INVENTION

The invention relates to a damping assembly for use in an unmanned vehicle, and particularly, but not exclusively, to a damping assembly for use in an unmanned aerial vehicle such as a multi-copter or a drone.

### BACKGROUND OF THE INVENTION

There has been a rapid development in the field of unmanned vehicles and particularly, in the technology of unmanned aerial vehicles (UAV) such as multi-copters which are often referred to as drones. A conventional UAV may comprise one or more propellers controlled by a flight control integrated circuit having one or more electronic controllers and/or sensors. Very often, UAVs are also equipped with a camera and/or a video camera which can be connected with or supported at the body of the UAV via a mount or a gimbal mechanism for capturing images and/or videos. These components are often delicate and are sensitive to shocks and/or vibrations, which can be caused by operation of the motors and/or propellers of the UAV, as well as external factors such as buffeting of the UAV by wind and shocks from landing and/or collisions with foreign objects. It is therefore desirable to improve the flight stability through use of shock absorbers and/or vibration dampers during the operation of the UAV.

### OBJECTS OF THE INVENTION

An object of the present invention is to provide a novel damping assembly for use in an unmanned aerial vehicle such as a multi-copter.

Another object of the present invention is to mitigate or obviate to some degree one or more problems associated with known damping devices for unmanned aerial vehicles, or at least to provide a useful alternative.

The above objects are met by the combination of features of the main claim; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

### SUMMARY OF THE INVENTION

In a first main aspect, the invention provides a damping assembly for use in an unmanned vehicle. The damping assembly comprises a positioning structure configured to support one or more components of the unmanned vehicle; a damping system comprising at least one first damping unit and at least one second damping unit arranged at the positioning structure, with the at least one first damping unit and the at least one second damping unit being deformable along an axis of deformation of the damping system to thereby reduce transmission of vibration to the supported components; wherein, in response to a force acting upon the positioning structure, the first damping unit is compressed along the axis of deformation, and simultaneously, the second damping unit is extended along the axis of deformation.

In a second main aspect, the invention provides a method of manufacturing a damping assembly according to the first main aspect. The method comprises the steps of providing a positioning structure for supporting one or more components of the unmanned vehicle; providing a damping system comprises at least one first damping unit and at least one second damping unit arranged at the positioning structure, the at least one first damping unit and the at least one second damping unit being deformable along an axis of deformation of the damping system to reduce transmission of vibration to the one or more supported components; wherein, in response to a force acting upon the positioning structure, the first damping unit is compressed along the axis of deformation, and simultaneously, the second damping unit is extended along the axis of deformation.

In a third main aspect, the invention provides an unmanned vehicle comprising a damping assembly according to the first main aspect.

The summary of the invention does not necessarily disclose all the features essential for defining the invention; the invention may reside in a sub-combination of the disclosed features.

### BRIEF DESCRIPTION OF THE DRAWINGS

The foregoing and further features of the present invention will be apparent from the following description of preferred embodiments which are provided by way of example only in connection with the accompanying figure, of which:

FIG. 1 is a perspective view showing a damping assembly in accordance with one embodiment of the present invention;

FIG. 2 is a top view showing the damping assembly of FIG. 1;

FIG. 3 is a side view showing the damping assembly of FIG. 1;

FIG. 4 is an exploded, perspective view showing the damping assembly of FIG. 1; and

FIG. 5 is an exploded, side view showing the damping assembly of FIG. 1.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

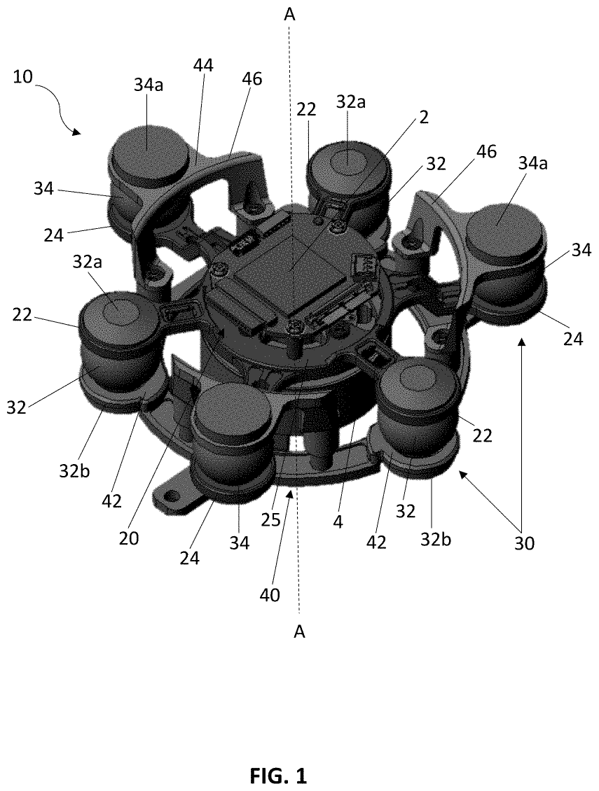

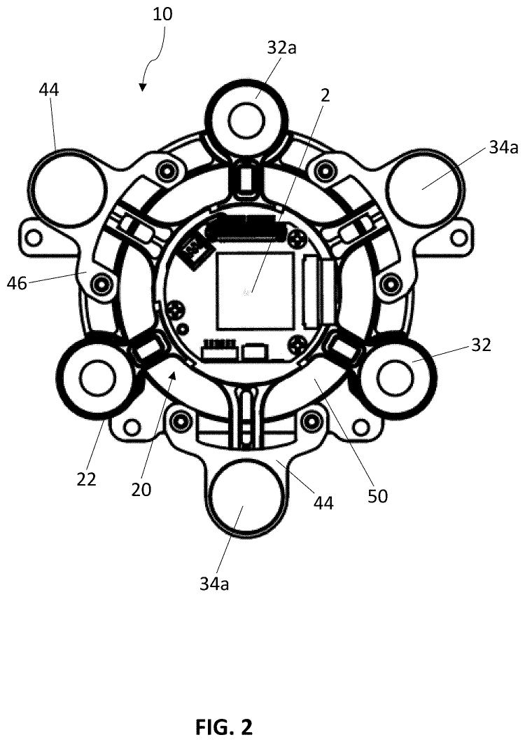

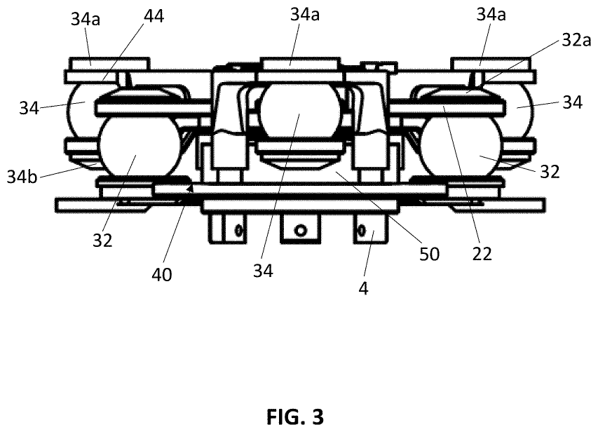

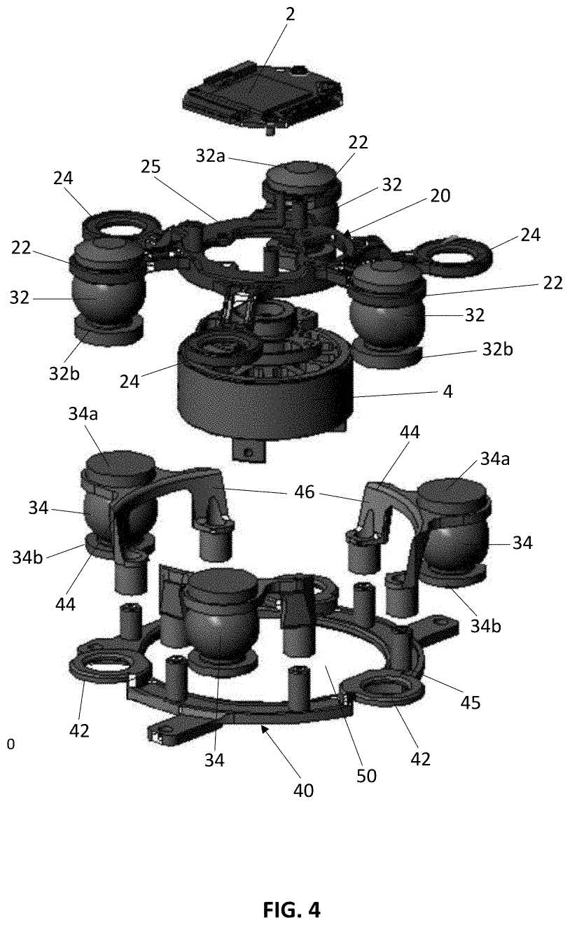

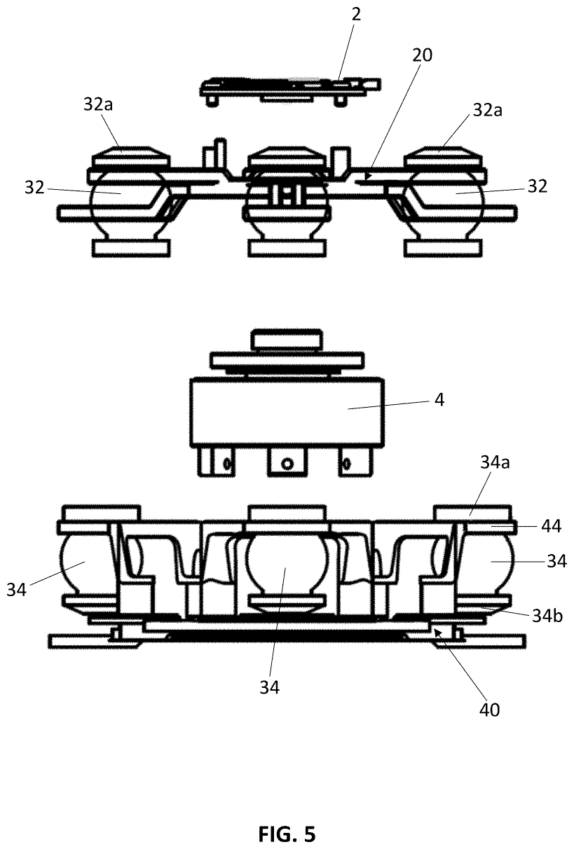

Referring to FIGS. 1 to 5, shown is a damping assembly 10 in accordance with an embodiment of the present invention. The damping assembly 10 can be arranged for use in an unmanned vehicle, such as an unmanned aerial vehicle (UAV) which may be a multi-copter or a drone, for absorbing vibrations or reducing transmission of vibrations to one or more vibration sensitive components of the unmanned vehicle. Preferably, the multi-copter is provided in the form of a drone configured for remotely piloted and/or autonomous flight. In the embodiment as shown in the figures, the damping assembly 10 comprises a positioning structure 20 configured to support the one or more vibration sensitive components, which may include one or more electronic components such as a microchip 2 for controlling operation of the UAV. The microchip 2 can be one or more sensor chips, and/or comprise one or more integrated circuits for controlling flight and/or motor operation such as a Field Oriented Control (FOC) controller chip, for example. The vibration sensitive components may further include one or more motors, such as the motor unit 4 as shown in the figures, which is electrically connectable with a gimbal structure (not shown) preferably at a lower side of the motor unit 4 for driving and controlling movement of the gimbal and thus, the mounted camera and/or video camera for image and/or video-capturing at adjustable angles during a flight. In one embodiment, the microchip 2 can be supported at an upper side of the positioning structure 20, and preferably, be fixedly connected on a central positioning ring 25 of the positioning structure 20; and the motor unit 4 can be fixedly connected at a lower side of the positioning structure 20, and preferably, under the central positioning ring 25 of the positioning structure 20.

The damping assembly 10 may further comprise a damping system 30 for providing the vibration absorption and/or reduction of the transmission of vibration. Particularly, the damping system 30 is deformable along an axis of deformation upon exertion thereon by an external force. In one embodiment, the damping system 30 may comprise at least one first damping unit 32 and at least one second damping unit 34 arranged at the positioning structure 20. For example, in the embodiment as shown in the figures, the damping system 30 comprises a plurality of first damping units 32 and a plurality of second damping units 34, such as three first damping units 32 and three second damping units 34. Each of the damping units 32, 34 can be provided in the form of a damping ball having an upper portion 32a, 34a and a lower portion 34a, 34b at respective ends. Preferably, the three first damping units 32 and the three second damping units 34 are arranged in an alternating arrangement. More preferably, the six alternate first and second damping units 32, 34 are positioned in a substantially circular arrangement to surround a central axis A-A of the damping assembly 10.

The first damping units 32 and the second damping units 34 are preferably formed of one or more resilient materials such that, when an external force is exerted thereon, the damping units 32 and 34 are deformable along the axis of deformation of the damping system 30 to thereby absorb or reduce transmission of any vibrations which may otherwise interfere with operation of the connected vibration sensitive components of the UAV. In one embodiment, the axis of deformation of the damping system 30 can be parallel to the central axis A-A of the damping assembly. For example, when an external force is applied on the positioning structure 20, such as when a downward force due to the weights of the vibration sensitive components 2 and/or 4 carried by the positioning structure 20, is exerted on the positioning structure 20, the first damping units 32 and the second damping units 34 are adapted to deform differently in response to the same force, that is, the first damping units 32 are adapted to be compressed along the axis of deformation, and simultaneously, the second damping units 34 are arranged to be extended or stretched along the axis of the deformation.

In one embodiment, the first and second damping units 32 and 34 are preferably formed of one or more resilient materials such as one or more flexible and/or elastic polymers such as silicone and/or rubber. The damping units 32, 34 may further comprise a hollow centre filled with a compressed air or a liquid for enhancing or adjusting the overall resiliency. In another embodiment, the damping units 32, 34 may also be configured with or comprise a metallic resilient member such as a spring or a wire rope, for example. In one further embodiment, the first and the second damping units 32, 34 may be formed of materials with different respective physical properties such as resiliency or density, etc. A person skilled in the relevant art should appreciate that the damping units are not limited to the specific configurations as described or illustrated. Instead, the damping units can be provided in any numbers, sizes and shapes, positional arrangements, and/or be formed of any materials in any configurations, as long as the variations do not depart from the inventive concept of the present invention.

Preferably, the positioning structure 20 is configured to comprise at least one first positioning means 22 and at least one second positioning means 24 for connecting the corresponding at least one first damping unit 32 and at least one second damping unit 34 at the positioning structure 20. Particularly, the positioning structure 20 connects each of the first damping units 32 at the respective upper portion 32a, and connects each of the second damping units 34 at the respective lower portion 34b. More preferably, the first damping units 32 are arranged to be compressed from their upper portion 32a under the action of the first positioning means 22 of the positioning structure 20 in response to the force acting downwardly upon the positioning structure 20; and the second damping units 34 are arranged to be stretched at their lower portion 34b under the action of the second positioning means 24 of the positioning structure 20 in response to the force acting downwardly upon the positioning structure 20. Yet it would be apparent that the first damping units 32 can also be stretched and extended at their upper portion 32a under the action of the first positioning means 22 in response to an upward, dragging force act upon the positioning structure 20; and the second damping units 34 are compressible from their lower portion 34b under the action of the second positioning means 24 in response to the same, upward dragging force, for example.

In one embodiment, each of the first and the second positioning means 22, 24 may comprise a ring member for engaging the corresponding upper portion 32a of the first damping unit 32 and the lower portion 34b of the second damping unit 34, respectively. More preferably, the ring members of the respective first and second positioning means 22, 24 are arranged to receivably engage a peripheral edge of the corresponding upper portion 32a of the first damping unit 32 and the lower portion 34b of the second damping unit 34 to thereby securely connect the damping units 32, 34 at the positioning structure 20.

Preferably, the damping assembly 10 may further comprise a supporting structure 40 for providing support to the first and the second damping units 32, 34, as well as the positioning member 20 of the assembly 10. In one embodiment, the supporting structure 40 is preferably positioned below the positioning structure 20 and connected with the positioning structure 20. Similar to the positioning structure 20, the supporting structure 40 may comprise at least one first supporting means 42 for supporting a lower portion 32b of the at least one first damping unit 32; and at least one second supporting means 44 for supporting an upper portion 34a of the at least one second damping unit 34. Likewise, each of the first and the second supporting means 42, 44 may comprise a ring member for engaging the corresponding lower portion 32b of the first damping unit 32 and the upper portion 34a of the second damping unit 34, respectively. More preferably, the ring members of the respective first and second supporting means 42, 44 are arranged to receivably engage a peripheral edge of the corresponding lower portion 32b of the first damping unit 32 and the upper portion 34a of the second damping unit 34 to thereby connect and support the damping units 32, 34 in between the positioning structure 20 and the supporting structure 40. In the embodiment as shown in the figures, the supporting structure 40 comprises three first supporting means 42 and three second supporting means 44.

Preferably, the three first supporting means 42 are arranged to be in axial alignment with the three first positioning means 22, and that the three second supporting means 44 are arranged to be in axial alignment with the three second positioning means 24 to thereby allow positioning of the respective three first damping units 32 and three second damping units 34 in between the positioning structure 20 and the supporting structure 40. In one preferred embodiment, the three first positioning means 22 and three second positioning means 24 of the positioning structure 20 are configured in an alternating arrangement with one another; and that the three first supporting means 42 and the three second supporting means 44 of the supporting structure 40 are configured in an alternating arrangement with one another, so that the three first damping units 32 and the three second damping units 34 are allowed to be positioned between the positioning structure 20 and the supporting structure 40 in an alternating arrangement, as described above. In one further embodiment, one or more of the second supporting means 44 each preferably comprise or are configured with a bridging means 46 arranged to extend over and above the corresponding second positioning means 24 to thereby interlock the positioning structure 20 with the supporting structure 40, as shown in the figures.

In one preferred embodiment, the three first positioning means 22 and the three second positioning means 24 of the positioning structure 20, and the three first supporting means 42 and the three second supporting means 44 of the supporting structure 40 are cooperatively arranged to surround a central space 50 for accommodating the one or more vibration sensitive components such as the motor unit 4, as shown in the figures. As described earlier, other components such as the microchip 2 may also be supported at the positioning structure 20 and above the central space 50. Particularly, the three first positioning means 22 and the three second positioning means 24 can be arranged to extend from and to surround the central positioning ring 25, and that the three first supporting means 42 and the three second supporting means 44 can be arranged to extend from and to surround a central supporting ring 45 positioned below the central positioning ring 25, as shown in the figures.

In one embodiment, the first damping units 32 and the second damping units 34 are releasably mounted at the positioning structure 20 and the supporting structure 40, that is, for the three first damping units 32 being releasably engaged at the first positioning means 22 and the first supporting means 42, and the three second damping unit 34 being releasably engaged at the second positioning means 24 and the second supporting means 44. This allows replacement of the damping units 32, 34 once they are worn out or damaged, or when a damping system 30 with a different resiliency is required to accommodate the weight of a different component to be carried by the UAV, for example.

The present invention also relates to a method of manufacturing a damping assembly 10 as described above. The method steps may comprise providing of the positioning structure 20 for supporting the vibration sensitive components 2, 4 of the unmanned vehicle, and arranging the first damping units 32 and the second damping unit 34 at the positioning structure 20. The first damping unit 32 and the second damping unit 34 are deformable such that, in response to a force acting upon the positioning structure 20, one of the first damping units 32 or the second damping units 34 can be compressed while the other one of the first damping units 32 or the second damping units 34 can be extended or stretched for vibrations absorption or for reducing transmission of the vibrations. Preferably, the positioning structure 20 may comprise at least one first positioning means 22 for engaging an upper portion 32a of the respective first damping units 32, and at least one second positioning means 24 for engaging a lower portion 34b of the respective second damping units 34. In response to the force acting upon the positioning structure 20, the first damping units 32 are compressible from the respective upper portion 32a by the at least one first positioning means 22, and the second damping units 34 are extendable or stretchable at the respective lower portion 34b by the at least one second positioning means 24. The method may further comprise the step of providing a supporting structure 40 comprising at least one first supporting means 42 for supporting a lower portion 32b of the respective first damping units 32, and at least one second supporting means 44 for supporting an upper portion 34b of the respective second damping units 34 for supporting the damping units 32, 34.

The present invention also relates to an unmanned vehicle which comprises the damping assembly 10 as described above. The unmanned vehicle can be a multi-copter, and preferably, the multi-copter is provided in the form of a drone configured for remotely piloted and/or autonomous flight.

The present invention is advantageous in that it provides a damping assembly adapted to substantially absorb vibrations and/or reduce or prevent transmission of vibrations experienced by an unmanned aerial vehicle during a flight to one or more vibration sensitive components carried by the vehicle. Particularly, the invention provides a damping system having two or two sets of damping units, which can be provided in the form of damper balls, adapted to deform in response to an external force applied thereon. For example, the damping system comprising the first and the second damping units each of which being adapted to be compressed or stretched in response to one external force, such as a downward force acting onto the system. The ability for the damping system to provide damping under a combination of compressing and stretching (or pulling) actions allows a more balanced and thus, effective damping when compared to the prior art technology, in which either one of a compression or a pulling action is generally provided for damping in accordance with the direction of the applied force. The present invention is found to have significantly improved vibration absorption and thus, reduce the interference to the carried components such as the microchip and/or the connected camera gimbal. This results in a more stable flight control, as well as an improved quality of images and/or videos captured by the camera or video camera connected at the UAV. The more balanced damping action also assists in reducing material fatigue at the damping units and thus, lengthening the overall lifespan of the damping assembly.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims hereof, any element expressed as a means for performing a specified function is intended to encompass any way of performing that function. The invention as defined by such claims resides in the fact that the functionalities provided by the various recited means are combined and brought together in the manner which the claims call for. It is thus regarded that any means that can provide those functionalities are equivalent to those shown herein.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art is referred to herein, such prior art does not constitute an admission that the prior art forms a part of the common general knowledge in the art.

1. A damping assembly for use in an unmanned vehicle, comprising:
a positioning structure configured to support one or more components of the unmanned vehicle;
a damping system comprising at least one first damping unit and at least one second damping unit arranged at the positioning structure, the at least one first damping unit and the at least one second damping unit being deformable along an axis of deformation of the damping system to thereby reduce transmission of vibration to the supported components;
wherein, in response to a force acting upon the positioning structure, the first damping unit is compressed along the axis of deformation, and simultaneously, the second damping unit is extended along the axis of deformation.

2. The damping assembly according to claim 1, wherein the positioning structure is connected to the at least one first damping unit at an upper portion of the at least one first damping unit, and is connected to the at least one second damping unit at a lower portion of the at least one second damping unit; wherein the at least one first damping unit is compressed from the upper portion by the positioning structure in response to the force acting upon the positioning structure, and the at least one second damping unit is stretched at the lower portion by the positioning structure in response to the force acting upon the positioning structure.

3. (canceled)

4. The damping assembly according to claim 2, wherein the positioning structure comprises at least one first positioning means and at least one second positioning means for connecting the at least one first damping unit and the at least one second damping unit at the positioning structure, respectively; wherein the at least one first positioning means and the at least one second positioning means each comprises a ring member for engaging the upper portion of the at least one first damping unit and the lower portion of the at least one second damping unit, respectively.

5. (canceled)

6. The damping assembly according to claim 3, further comprising a supporting structure for supporting the at least one first damping unit and the at least one second damping unit of the damping system connected at the positioning structure; wherein the supporting structure comprises at least one first supporting means for supporting a lower portion of the at least one first damping unit, and at least one second supporting means for supporting an upper portion of the at least one second damping unit; wherein the at least one first supporting means and the at least one second supporting means each comprises a ring member for supporting the lower portion of the at least one first damping unit and the upper portion of the at least one second damping unit, respectively.

7-8. (canceled)

9. The damping assembly accordingly to claim 4, wherein the at least one second supporting means of the supporting structure comprises a bridging means arranged to extend over and above the at least one second positioning means to interlock the positioning structure with the supporting structure.

10. The damping assembly according to claim 5, wherein the supporting structure is positioned below the positioning structure.

11. The damping assembly according to claim 4, wherein the at least one first supporting means is in axial alignment with the at least one first positioning means, and the at least one second supporting means is in axial alignment with the at least one second positioning means, thereby positioning the respective at least one first and second damping units in between the positioning structure and the supporting structure.

12. The damping assembly according to claim 1, wherein the at least one first damping unit comprises a plurality of first damping units, and the at least one second damping unit comprises a plurality of second damping units.

13. The damping assembly according to claim 1, wherein the axis of deformation of the damping system is parallel to a central axis of the damping assembly.

14. The damping assembly according to claim 4, wherein the positioning structure comprises three first positioning means and three second positioning means configured in an alternating arrangement with one another; and the supporting structure comprises three first supporting means and three second supporting means configured in an alternating arrangement with one another; wherein the positioning structure and the supporting structure are arranged to position therebetween three first damping units and three second damping units in an alternating arrangement.

15. (canceled)

16. The damping assembly according to claim 10, wherein the three first positioning means and the three second positioning means of the positioning structure, and the three first supporting means and the three second supporting means of the supporting structure are cooperatively arranged to surround a central space for accommodating the one or more components of the unmanned vehicle.

17. The damping assembly according to claim 10, wherein the positioning means comprises a central positioning ring with the three first positioning means and the three second positioning means being arranged to extend from and to surround the central positioning ring; and wherein the supporting means comprises a central supporting ring with the three first supporting means and the three second supporting means being arranged to extend from and to surround the central supporting ring.

18. (canceled)

19. The damping assembly according to claim 11, wherein the central space is arranged to accommodate a motor of the unmanned vehicle connected at the positioning structure.

20. The damping assembly according to claim 11, wherein the positioning structure is configured to support an electronic component of the unmanned vehicle above the central space.

21. The damping assembly according to claim 7, wherein the at least one first damping unit is releasably engaged at the first positioning means and the first supporting means, and the at least one second damping unit is releasably engaged at the second positioning means and the second supporting means.

22. The damping assembly according to claim 1, wherein one or more of the at least one first damping unit and the at least one second damping unit are formed of one or more polymeric and/or metallic materials and are air-filled or liquid-filled; wherein the at least one first damping unit and the at least one second damping unit are formed of materials with same or different physical properties.

23-24. (canceled)

25. A method of manufacturing a damping assembly according to claim 1, comprising steps of:
providing a positioning structure for supporting one or more components of the unmanned vehicle;
providing a damping system comprising at least one first damping unit and at least one second damping unit arranged at the positioning structure, the at least one first damping unit and the at least one second damping unit being deformable along an axis of deformation of the damping system to reduce transmission of vibration to the one or more supported components;
wherein, in response to a force acting upon the positioning structure, the first damping unit is compressed along the axis of deformation, and simultaneously, the second damping unit is extended along the axis of deformation.

26. The method according to claim 17, wherein the positioning structure comprises at least one first positioning means for engaging an upper portion of the at least one first damping unit, and at least one second positioning means for engaging a lower portion of the at least one second damping unit; wherein, in response to the force acting upon the positioning structure, the at least one first damping unit is compressed from the upper portion by the at least one first positioning means, and the at least one second damping unit is stretched at the lower portion by the at least one second positioning means.

27. The method according to claim 18, further comprising the step of providing a supporting structure comprising at least one first supporting means for supporting a lower portion of the at least one first damping unit, and at least one second supporting means for supporting an upper portion of the at least one second damping unit.

28. (canceled)

29. An unmanned vehicle, comprising a damping assembly according to claim 1.
